(19) United States
(12) Patent Application Publication
(10) Pub. No.: US 2020/0143377 A1
(43) Pub. Date: May 7, 2020

(54) SYSTEMS AND METHODS FOR USER IDENTITY AUTHENTICATION

(71) Applicant: JEWEL PAYMENTECH PTE LTD, Singapore (SG)

(72) Inventors: Jer-Wei LAM, Singapore (SG); Wooi Siang LEE, Singapore (SG); Sandra Mei Ling CHEIM, Singapore (SG); Azim Adil YAZDANI, Singapore (SG)

(21) Appl. No.: 16/495,977

(22) PCT Filed: Mar. 23, 2018
(86) PCT No.: PCT/SG2018/050127

§ 371 Date: Sep. 20, 2019

(30) Foreign Application Priority Data
Mar. 23, 2017 (SG) 10201702392P

(51) Int. Cl. G06Q 20/40; G06F 21/36; G06F 21/32; G06Q 20/34; G06Q 40/02; G06Q 20/42; G06K 9/00

(52) U.S. Cl. CPC G06Q 20/4016; G06F 21/36; G06F 21/32; G06K 9/00288; G06Q 20/40145; G06Q 40/02; G06Q 20/42; G06Q 20/341

(57) ABSTRACT

Systems and methods for user identity authentication, for example in know your customer (KYC) procedures are described. A method for user identity authentication comprises: receiving user authentication data from a user device, the user authentication data comprising data indicative of a payment card account or bank account associated with the user, data indicative of an identity card of the user, and an image of the user captured by the user device; determining a name associated with the payment card or bank account associated with the user; determining a name associated with the identity card of the user; performing a name verification by comparing the name associated with the payment card or bank account associated with the user with the name associated with the identity card of the user; performing an image verification by comparing the image of the user with an image associated with the identity card of the user; performing an account verification by generating a transaction on the payment card or bank account associated with the user and receiving an account verification response; and generating a user identity verification indication indicating that the identity of user has been authenticated if the name verification, the image verification and the account verification were successful.

### FIELD

The present disclosure relates to user identity authentication, in particular, the present disclosure provides systems and methods for performing remote authentication of a user's identity.

### BACKGROUND

Many businesses including financial organizations such as banks are required to perform know your customer (KYC) procedures to verify the identity of their clients. In many jurisdictions, banking and anti-money laundering regulations require organizations to carry out such procedures and store verifiable records that the procedures have been carried out. However, carrying out such procedures can be time consuming, and inconvenient for customers, particularly when the process has to be repeated each time the customer registers with a new organization.

### SUMMARY OF THE INVENTION

The present disclosure provides systems and methods which allow KYC procedures to be carried out remotely for customers who have already undergone a KYC process with a trusted institution. The systems and methods of the present disclosure therefore remove the requirement for a customer to be physically present at a location such as a bank branch to conduct the KYC process.

According to a first aspect of the present disclosure, a system for authenticating the identity of a user is described. The system comprises a computer processor and a storage device storing executable instructions which are operative to cause the processor to: receive user authentication data from a user device, the user authentication data comprising data indicative of a payment card account or bank account associated with the user, data indicative of an identity card of the user, and an image of the user captured by the user device; determine a name associated with the payment card or bank account associated with the user; determine a name associated with the identity card of the user; perform a name verification by comparing the name associated with the payment card or bank account associated with the user with the name associated with the identity card of the user; perform an image verification by comparing the image of the user with an image associated with the identity card of the user; perform an account verification by generating a transaction on the payment card or bank account associated with the user and receiving an account verification response; and generate a user identity verification indication indicating that the identity of user has been authenticated if the name verification, the image verification and the account verification were successful.

In an embodiment, the storage device further stores instructions operative by the processor to: perform the account verification by generating a transaction for an authentication amount on the payment card or bank account associated with the user; receiving a user response indicating an authentication amount retrieved by the user; and comparing the authentication amount retrieved by the user with the authentication amount, wherein the account verification is successful if the authentication amount retrieved by the user matches the authentication amount.

In an embodiment, wherein the storage device further stores instructions operative by the processor to: perform the account verification by generating a transaction authorization request on the payment card associated with the user; sending the transaction authorization request to an issuer of the payment card and receiving a transaction authorization response from the issuer of the payment card, wherein the account verification is successful if the authorization response indicates that user verification was successfully carried out by the issuer of the payment card. Transactions (both debiting and crediting ones) on the payment card are linked directly to the customer's Current/Savings Account (CASA) Bank Account for which a KYC had been done prior to account opening.

The user identity verification indication may comprise an indication of the account number for the CASA account thus providing a link between the CASA account for which a KYC had already been carried out and the KYC procedure for which the user is being authenticated.

In an embodiment, the data indicative of a payment card account or bank account of the user comprises an image of a payment card of the user, and wherein the storage device further stores instructions operative by the processor to: determine the name associated with the payment card or bank account by extracting a name from the image of the payment card of the user.

In an embodiment, the data indicative of an identity card of the user comprises an image of an identity card of the user, and wherein the storage device further stores instructions operative by the processor to: determine the name associated with the identity card by extracting a name from the image of the identity card of the user.

In an embodiment, the storage device further stores instructions operative by the processor to: perform a fraud detection on the authentication data for the user.

In an embodiment, the user identity verification indication comprises an image of the identity card of the user.

In an embodiment, the storage device further stores instructions operative by the processor to: determine an identifier of an issuing institution associated with the payment card or bank account associated with the user and compare the identifier of the issuing institution with a list of verified issuing institutions, wherein the identity verification indication indicating that the identity of user has been authenticated is generated if the name verification, the image verification and the account verification were successful and the identifier of the issuing institution matches a verified issuing institution from the list of verified issuing institutions.

According to a second aspect of the present disclosure, a method of authenticating the identity of a user is described. The method comprises: receiving user authentication data from a user device, the user authentication data comprising data indicative of a payment card account or bank account associated with the user, data indicative of an identity card of the user, and an image of the user captured by the user device; determining a name associated with the payment card or bank account associated with the user; determining a name associated with the identity card of the user; performing a name verification by comparing the name associated with the payment card or bank account associated with the user with the name associated with the identity card of the user; performing an image verification by comparing the image of the user with an image associated with the identity card of the user; performing an account verification by generating a transaction on the payment card or bank account associated with the user and receiving an account verification response; and generating a user identity verification indication indicating that the identity of user has been authenticated if the name verification, the image verification and the account verification were successful.

Embodiments may be implemented as a network of communicating devices (i.e. a “computerized network”). Further embodiments comprise a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

In the following, embodiments of the present invention will be described as non-limiting examples with reference to the accompanying drawings in which:

FIG. 1 is a block diagram showing a system for user identity authentication according to an embodiment of the present invention;

FIG. 2 is a block diagram showing functional modules of a user authentication server according to an embodiment of the present invention;

FIG. 3 is a flow chart showing a method of authenticating a user identity according to an embodiment of the present invention;

FIG. 4 is a flow diagram illustrating the generation of user authentication data in an embodiment of the present invention;

FIG. 5 is a block diagram showing user authentication data used in an embodiment of the present invention;

FIG. 6 is a flow diagram showing a method of user account verification according to an embodiment of the present invention;

FIG. 7 is a flow diagram showing a method of user account verification according to an embodiment of the present invention; and

FIG. 8 is a block diagram showing a user identity verification output from an embodiment of the present invention.

### DETAILED DESCRIPTION

Embodiments of the present invention allow know your customer (KYC) procedures to be carried out by organizations such as financial institutions (e.g. Bank A) by identifying customers who have already undergone a KYC process with a trusted financial institution (e.g. Bank B). The systems and methods remove the need to have a customer physically present at the Bank Branch and allows customers to complete the verification process remotely.

International payment networks such as Visa and MasterCard have in recent years introduced debit electronic payment cards to replace proprietary automated teller machine (ATM) cards that banks previously provided to their customers. By using the international payment network infrastructure (or alternatively, a domestic network), the systems and methods described in more detail below verify account ownership of any bank that has issued a payment card on that particular brand.

These debit cards can be used for retail transactions either in electronic commerce (via the internet) or at the physical brick and mortar point of sale devices. Transactions (both debiting and crediting ones) are linked directly to the customer's Current/Savings Account (CASA). Embodiments of the present invention allow KYC procedures to be carried out relying on the KYC procedure previously carried out for the CASA.

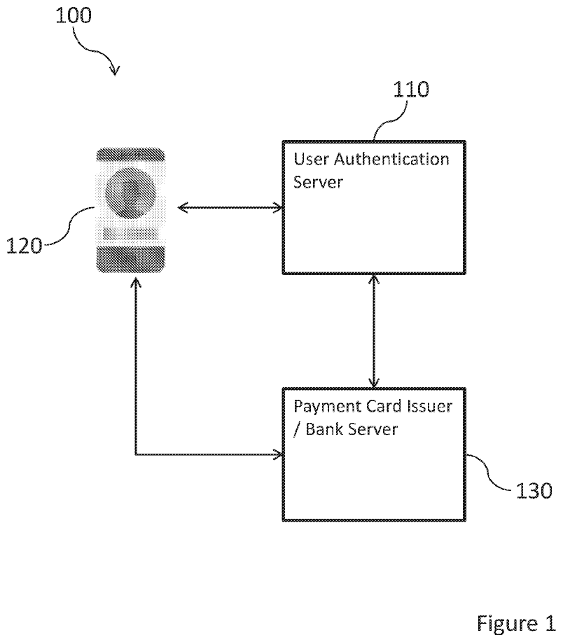

FIG. 1 is a block diagram showing a system for user identity authentication according to an embodiment of the present invention. The system 100 comprises a user authentication server 110 which performs methods of verifying and authenticating a user identity as described in more detail below. The system 100 further comprises a user device 120 such as a smart phone with which the user inputs user authentication data which is processed by the user authentication server 110 to verify and authenticate the user's identity. The user authentication server 110 is coupled to a payment card issuer/bank server 130 via a network, for example a payment network. The payment card issuer/bank server 130 is associated with a bank or financial institution with which the user has already opened a bank account or payment card account and which has already performed a KYC procedure for the user. The user authentication server 110 performs a verification of the user identity which in part relies on the previously performed KYC procedure.

As will be described in more detail below, in some embodiments of the present invention the payment card issuer/bank server 130 may send information such as a one-time password, or perform authentication of the user through a connection with the user device 120. This connection may be over the internet, or over a mobile telephone network.

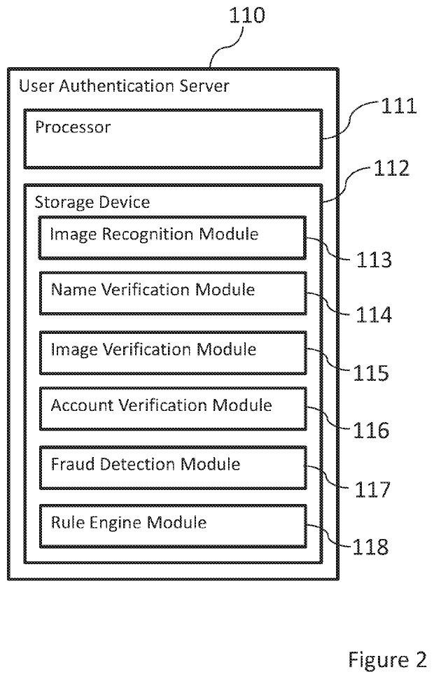

FIG. 2 is a block diagram showing functional modules of a user authentication server according to an embodiment of the present invention. Typically, the methods described below are implemented by a computer or a number of computers each having a data-processing unit. As shown in FIG. 2, the authentication server 110 comprises a processor 110 and a storage device 112 which stores programs which are loaded into a random access memory (RAM) and executed by the processor 111 when the programs are selected for execution. As shown in FIG. 2, the storage device stores an image recognition module 113, a name verification module 114, an image verification module 115, an account verification module 116, a fraud detection module 117 and a rule engine module 118. Each of the program modules comprise non-transitory instructions operative by the processor 111 to perform various operations of the method of the present disclosure. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will be appreciated that, while a software implementation of the modules is described herein, these may alternatively be implemented as one or more hardware modules (such as field-programmable gate array(s) or application-specific integrated circuit(s)) comprising circuitry which implements equivalent functionality to that implemented in software. Further, while only one processor 111 is shown, multiple processors may be present. Thus, while instructions may be discussed as executed by a processor, the instructions may be executed simultaneously, serially, or otherwise executed by one or multiple processors.

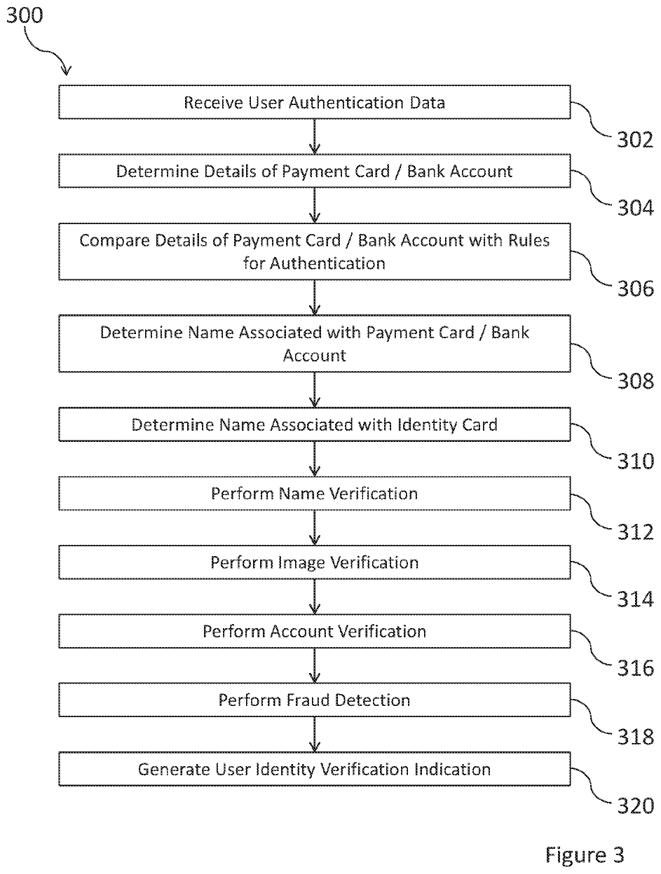

The operation of the user authentication server 110 and the program modules will now be described in more detail with reference to FIG. 3.

FIG. 3 is a flow chart showing a method of authenticating a user identity according to an embodiment of the present invention.

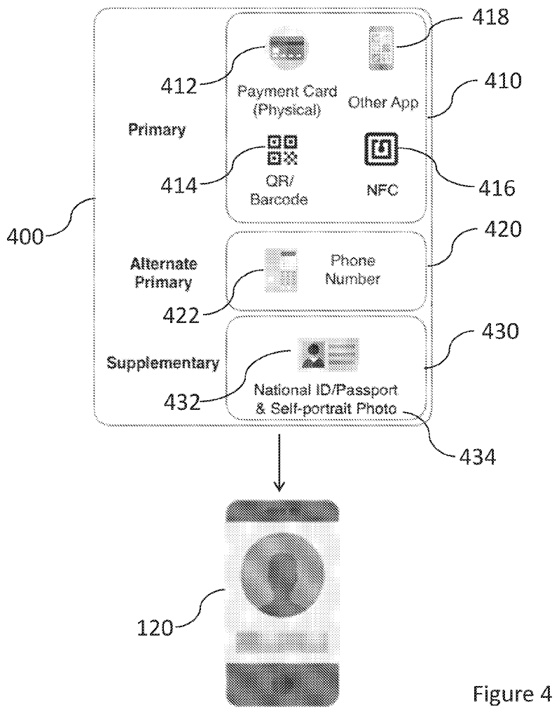

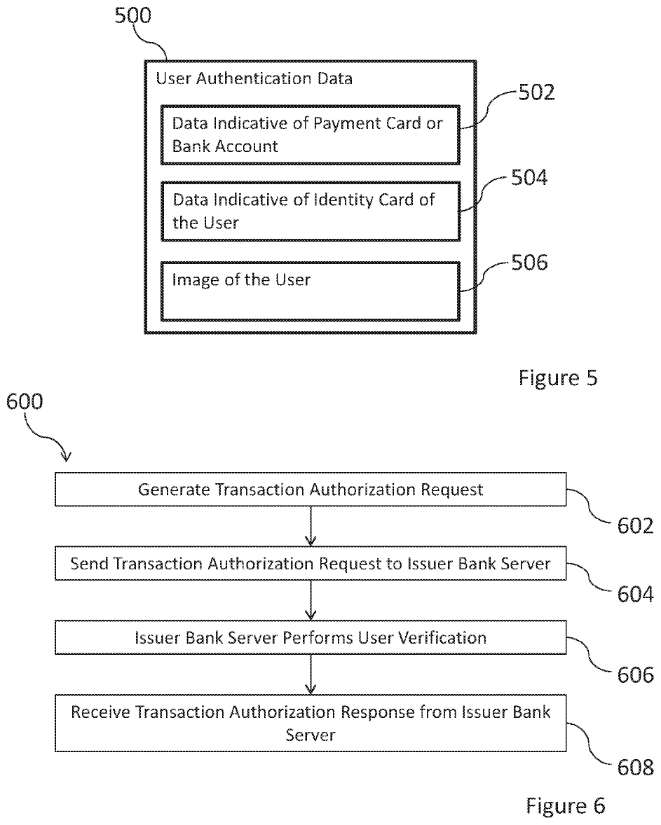

In step 302, the user authentication server 110 receives user authentication data from the user device 120. The content and generation of the user authentication data will now be described with reference to FIGS. 4 and 5.

FIG. 4 is a flow diagram illustrating the generation of user authentication data in an embodiment of the present invention. The user authentication data is generated by the user device 120 capturing data from a set of user inputs 400.

The user inputs 400 include a primary input which is an indication of an account number or payment card number of the user. It is this account or payment card is an existing account with a bank or other institution which has already carried out a KYC process for the user.

The user may input the payment card details using a physical payment card 412. The input may be manual, for example by the user entering their payment card number, expiry date and other information. In some embodiments, the user uses a camera of the user device 120 to capture an image of the physical payment card 412. The user captures an image of the physical payment card and the Payment Account Number (PAN) and name associated with the PAN (PAN Name) is extracted using image recognition technology. Alternatively, the user device may capture the image of the payment card and provide the image to the user authentication server 110 as part of the user authentication data.

In some embodiments, the user is provided with an optically readable QR code 414 by the bank or financial institution with which the account is held. In order to capture the details with the user device 120, the user can therefore read the QR code 414 using a camera of the user device 120.

The user device 120 may be enabled to read near field communication (NFC) devices. The user may input the payment card details by reading a NFC chip 416 embedded in the payment card with the NFC reader of the user device 120.

In some implementations, the user device 120 may have a payment app or other app 418 which already stores details of the payment card or bank account and the information may be captured from this app 418 rather than being input by the user.

As an alternative to inputting payment card or account details, the user may instead input a telephone number which is registered against their bank details or payment card. In some embodiments, the telephone number is input by via automatic identification through the mobile device's operating system.

The information input by the user also includes supplementary information 430 which may be required to complete the KYC process. This includes data indicative of an identity card 432 of the user. The identity card of the user may be a passport, a national identity card, or other photo ID such as a driving license. The user may input the indication of the identity card 432 by capturing an image of the identity card 432 using the camera of the user device 120. Alternatively, the user may enter an identifier of the identity card 432, such as a passport number.

Supplementary information 430 also comprises a self-portrait image 434 or self-portrait video of the user which is captured on the camera of the user device 120.

The user device 120, captures the information described above and generates user authentication data which is described below with reference to FIG. 5.

FIG. 5 is a block diagram showing user authentication data used in an embodiment of the present invention. The user authentication data 500 comprises data indicative of a payment card or bank account 502, data indicative of an identity card of the user 504 and an image of the user 506. It will be appreciated that the order of steps shown in FIG. 3 may be changed.

The data indicative of a payment card or bank account 502 may comprise a payment card or bank account number and other payment card or bank account details such as the expiry date, a security code of the payment card, the card type or classification of the payment card, a sort code associated with the bank account, and the issuing bank. Alternatively, the data indicative of a payment card or bank account 502 may comprise an image of the payment card, or information such as a telephone number which allows the payment card or bank account to be uniquely identified.

The data indicative of an identity card of the user 504 may comprise an identity card number and other information from an identity card such as a expiry date and other information included on the identity card. Alternatively, the data indicative of an identity card of the user 504 may comprise an image of the identity card of the user.

The image of the user 506 is an image captured by the user device 120. The image may be a still image or a video of the user.

Returning now to FIG. 3, in step 304, user authentication server 110 determines details of the payment card or bank account of the user from the data indicative of the payment card or bank account 502. When the user authentication data 500 includes an indication of the payment card number or bank account number, then step 304 may be omitted. If the data indicative of a payment card or user bank account is an image of the payment card of the user, then in step 304, the image recognition module 113 extracts information on the payment card of the user from the image. This information may comprise the payment card number, expiry data and security code which may be identified and converted to text or numbers using an optical character recognition algorithm. The information extracted from the image may also include an indication of the payment card type and an indication of the issuing bank. In some embodiments, an indication of the payment card type and an indication of the issuing bank may be determined using the payment card number.

The image recognition module 113 may extract an indication of a name associated with the payment card from the image of the payment card. In some embodiments, the account verification module 116 may determine a name associated with the payment card or bank account.

If a phone number is used as the data indicative of a payment card, then account verification module 116 of the user authentication server 110 may perform a matching of phone number data and account number from an internal or external database. The output will then be the PAN and the PAN name.

In step 306, the rule engine 118 compares details of the payment card/bank account with a set of rules for authentication. The rules for authentication may specify particular banks or financial institutions which are verified for KYC checks. In such cases, the rule engine 118 may compare the issuing bank of the payment card with a list of banks verified for KYC checks. The financial institution for this the KYC check is being performed may specify a set of criteria or rules for carrying out the KYC checks. These rules may be that only payment cards or bank accounts from a certain institution or set of institution are allowed for the KYC authentication. The rules may specify that only certain types of bank account or payment card are allowed for KYC checks, for example, only debit cards may be used in the verification of KYC checks, or only certain class of credit card such as gold or platinum may be used in KYC checks. The rules may specify that only payment cards or bank accounts held with banks in a certain country may be used for the KYC authentication.

In step 308, the user authentication server 110 determines the name associated with the payment card or bank account. As described above the determination of the name associated with the payment card or bank account may comprise the image recognition module 113 extracting the name from an image of the payment card. Alternatively, the name associated with the payment card may be looked up in a database of the payment card issuer using the payment card number.

In step 310, the user authentication server 110 determines a name associated with the identity card. This may comprise the image recognition module 113 extracting the name from an image of the identity card. Alternatively, the name associated with the identity card may be looked up in an identity card database.

In step 312, the name verification module 114 performs a name verification for the user by comparing the name associated with the payment card or bank account with the name associated with the identity card. In some embodiments, an exact match may be required for name verification. In other embodiments, variations such as including an initial in place of a first name or the inclusion/omission of a title such as MR or MS may be allowed in the name verification. The name verification is successful if the name associated with the payment card or bank account matches the name associated with the identity card.

In step 314, the image verification module 115 performs image verification by comparing an image extracted from the identity card with the image of the user 506 included in the user authentication data 500. A facial recognition algorithm may be applied to the two images to determine a matching score and the matching score compared with a threshold to determine if the images match. The image verification is successful if the image associated with the identity card and the image included in the user authentication data 500 match.

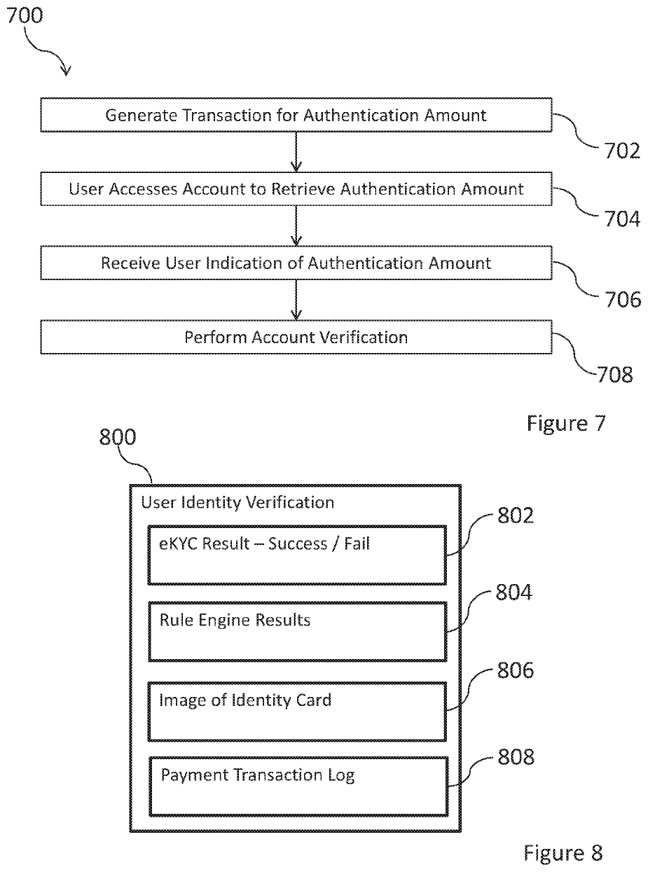

In step 316, the account verification module 116 performs account verification of the user using the payment card number or account number. Two possible implementations of the account verification are envisaged and these implementations are described below with reference to FIGS. 6 and 7.

FIG. 6 is a flow diagram showing a method of user account verification according to an embodiment of the present invention. The method 600 shown in FIG. 6 utilizes an authentication carried out by the payment card issuer or payment network to authenticate the user. An example of such an authentication is a One Time Password (e.g. Visa's 3D Secure Platform).

In step 602, the user authentication server 110 generates a transaction authorization request for the payment card. In step 604, the payment transaction authorization request is sent to the issuer bank server 130 over a payment network. In step 606, the issuer bank performs a user verification. The user verification may comprise the user being prompted to enter a one-time password sent via a text message or email message. Alternatively, the user may be prompted to perform a biometric authentication such as applying a fingerprint to a sensor on the user device 120. The issuer bank then generates transaction authorization response which is sent to the user authentication server 110.

In step 608, the user authentication server 110 receives the transaction authorization response and if the transaction authorization response indicates that the authentication was successful, the account verification is successful.

FIG. 7 is a flow diagram showing a method of user account verification according to an embodiment of the present invention. The method 700 shown in FIG. 7 involves the user verifying a randomly generated transaction amount (either as a credit or debit value) and correctly presenting that information back.

In step 702, the account verification module 116 generates a transaction for an authentication amount. The authentication amount is a randomly selected amount which is credited or debited from the account or payment card associated with the user.

In step 704, the user accesses their account to retrieve the authentication amount. Step 704 may comprise the user logging onto an internet banking site to check recent transactions on the account and retrieving the authentication amount as the transaction amount. Alternatively, the user may check recent transactions on an ATM or by visiting a bank branch.

In step 706, the user enters an indication of the retrieved authentication amount and enters this into the user device in response to a prompt. The indication of the authentication amount is sent to the user authentication server 110.

In step 708, the account verification module performs account verification by comparing the authentication amount in the transaction with the value for the authentication amount input by the user. If the amounts match then the account verification is successful.

Returning now to FIG. 3, in step 318, the fraud detection module 118 performs fraud detection. A variety of possible fraud detection methods are envisaged. The fraud detection may comprise the image recognition module 113 analyzing the image of the user 506 which is a self-portrait image or video to identify potential risk issues. The output is a pass or fail. Facial recognition and matching against known negative identifications (e.g. fraudsters, blacklisted individuals) may be carried out which will trigger a fail. Object, background image recognition and file metadata analysis to identify if image was indeed taken by the user and not a static image typically used by fraudsters. If a fraudulent static image is used, it will trigger a fail result.

The fraud detection may comprise the image recognition module 113 analyzing and classifying an image of the user identity card as either genuine or counterfeit. A genuine identification will trigger a pass or a fail if otherwise. Similarly computer image analysis and classification of either a genuine or counterfeit Passport. A genuine identification will trigger a pass or a fail if otherwise.

The fraud detection may comprise device and application fraud detection that performs additional risk checks on the device data. The output is a pass or fail. Device identification and matching against known negative identification (devices previously used for fraud)—which will trigger a fail. Identification of bogus devices such as a stolen device, spoofed device that indicates a high probability of fraud—which will trigger a fail.

In step 320, the user authentication server 110 generates a user identity verification indication. The user identity verification indication indicates the result of the user authentication is the name verification, the image verification and the account verification were all successful and none of the fraud detection tests are failed, then a positive user identity verification indication is generated in step 320.

The user identity verification indication may be stored in a repository for validation purposes. In order to provide a record of the checks carried out, the user identity verification indication may comprise evidence of the checks carried out.

FIG. 8 is a block diagram showing a user identity verification output from an embodiment of the present invention. The user identity verification 800 comprises a eKYC result indication 802 which indicates whether the verification was a pass or a file. The user identity verification 800 further comprises an indication of the rule engine result 804, an image of the identity card 806, an a payment transaction log. The rule engine results 804 may include an indication of the bank which the KYC process relied upon and may also comprise an indication of the type of payment card or bank account used in the user identity verification. The image of the identity card 806 may be required as evidence that an identity check has taken place. The payment transaction log may comprise an indication of the successfully authorized transaction using the method shown in FIG. 6 or an indication of the bank account that was used in the method shown in FIG. 7.

Whilst the foregoing description has described exemplary embodiments, it will be understood by those skilled in the art that many variations of the embodiments can be made within the scope and spirit of the present invention.

1. A system for authenticating the identity of a user, the system comprising a computer processor and a storage device storing executable instructions which are operative to cause the processor to:
receive user authentication data from a user device, the user authentication data comprising data indicative of a payment card account or bank account associated with the user, data indicative of an identity card of the user, and an image of the user captured by the user device;
determine a name associated with the payment card or bank account associated with the user:
determine a name associated with the identity card of the user;
perform a name verification by comparing the name associated with the payment card or bank account associated with the user with the name associated with the identity card of the user;
perform an image verification by comparing the image of the user with an image associated with the identity card of the user;
perform an account verification by generating a transaction on the payment card or bank account associated with the user and receiving an account verification response; and
generate a user identity verification indication indicating that the identity of user has been authenticated if the name verification,the image verification and the account verification were successful.

2. A system according to claim 1, wherein the storage device further stores instructions operative by the processor to: perform the account verification by generating a transaction for an authentication amount on the payment card or bank account associated with the user receiving a user response indicating an authentication amount retrieved by the user; and comparing the authentication amount retrieved by the user with the authentication amount, wherein the account verification is successful if the authentication amount retrieved by the user matches the authentication amount.

3. A system according to claim 1, wherein the storage device further stores instructions operative by the processor to: perform the account verification by generating a transaction authorization request on the payment card associated with the user; sending the transaction authorization request to an issuer of the payment card and receiving a transaction authorization response from the issuer of the payment card, wherein the account verification is successful if the authorization response indicates that user verification was successfully carried out by the issuer of the payment card.

4. A system according to claim 1, wherein the user identity verification indication further comprises an indication of the bank account associated with the user or a bank account associated with the payment card associated with the user.

5. A system according to claim 1, wherein the data indicative of a payment card account or bank account of the user comprises an image of a payment card of the user, and wherein the storage device further stores instructions operative by the processor to: determine the name associated with the payment card or bank account by extracting a name from the image of the payment card of the user.

6. A system according to claim 1, wherein the data indicative of an identity card of the user comprises an image of an identity card of the user, and wherein the storage device further stores instructions operative by the processor to: determine the name associated with the identity card by extracting a name from the image of the identity card of the user.

7. A system according to claim 1, wherein the storage device further stores instructions operative by the processor to: perform a fraud detection on the authentication data for the user.

8. A system according to claim 1, wherein the user identity verification indication comprises an image of the identity card of the user.

9. A system according to claim 1, wherein the storage device further stores instructions operative by the processor to: determine an identifier of an issuing institution associated with the payment card or bank account associated with the user and compare the identifier of the issuing institution with a list of verified issuing institutions, wherein the identity verification indication indicating that the identity of user has been authenticated is generated if the name verification, the image verification and the account verification were successful and the identifier of the issuing institution matches a verified issuing institution from the list of verified issuing institutions.

10. A method of authenticatimg the identity of a user, the method comprising:
receiving user authentication data from a user device, the user authentication data comprising data indicative of a payment card account or bank account associated with the user, data indicative of an identity card of the user, and an image of the user captured by the user device;
determining a name associated with the payment card or bank account associated with the user;
determining a name associated with the identity card of the user;
performing a name verification by comparing the name associated with the payment card or bank account associated with the user with the name associated with the identity card of the user:
performing an image verification by comparing the image of the user with an image associated with the identity card of the user;
performing an account verification by generating a transaction on the payment card or bank account associated with the user and receiving an account verification response; and
generating a user identity verification indication indicating that the identity of user has been authenticated if the name verification, the image verification and the account verification were successful.

11. A method according to claim 10, wherein the account verification comprises generating a transaction for an authentication amount on the payment card or bank account associated with the user; receiving a user response indicating an authentication amount retrieved by the user; and comparing the authentication amount retrieved by the user with the authentication amount, wherein the account verification is successful if the authentication amount retrieved by the user matches the authentication amount.

12. A method according to claim 10, wherein the account verification comprises generating a transaction authorization request on the payment card associated with the user;
sending the transaction authorization request to an issuer of the payment card and receiving a transaction authorization response from the issuer of the payment card, wherein the account verification is successful if the authorization response indicates that user verification was successfully carried out by the issuer of the payment card.

13. A method according to claim 10, wherein the user identity verification indication further comprises an indication of the bank account associated with the user or a bank account associated with the payment card associated with the user.

14. A method according to claim 10, wherein the data indicative of a payment card account or bank account of the user comprises an image of a payment card of the user, and wherein determining a name associated with the payment card or bank account comprises extracting a name from the image of the payment card of the user.

15. A method according to claim 10, wherein the data indicative of an identity card of the user comprises an image of an identity card of the user, and wherein determining a name associated with the identity card comprises extracting a name from the image of the identity card of the user.

16. A method according to claim 10, further comprising performing a fraud detection on the authentication data for the user.

17. A method according to claim 10, wherein the user identity verification indication comprises an image of the identity card of the user.

18. A method according to claim 10, further comprising determining an identifier of an issuing institution associated with the payment card or bank account associated with the user and comparing the identifier of the issuing institution with a list of verified issuing institutions, wherein the identity verification indication indicating that the identity of user has been authenticated is generated if the name verification, the image verification and the account verification were successful and the identifier of the issuing institution matches a verified issuing institution from the list of verified issuing institutions.

19. A computer readable carrier medium carrying processor executable instructions which when executed on a processor cause the processor to carry out a method according to claim 10.
